(19) United States
(12) Patent Application Publication
(10) Pub. No.: US 2005/0233162 A1
(43) Pub. Date: Oct. 20, 2005

(54) Metal matrix composite bar assemblies

(75) Inventors: Brian E. Joseph, Wheeling, WV (US); Matthew M. Rowe, Wheeling, WV (US)

Correspondence Address: PHILIP DOUGLAS LANE, P.O. BOX 651295, POTOMAC FALLS, VA, 20165-1295, US

(73) Assignee: Touchstone Research Laboratory, Ltd.

(21) Appl. No.: 10/995,531

(22) Filed: Nov. 24, 2004

Related U.S. Application Data
(60) Provisional application No. 60/525,837, filed on Dec. 1, 2003.

(51) Int. Cl. B32B 5/00

(52) U.S. Cl. 428/609; 428/293.1; 403/292

(57) ABSTRACT

The present invention provides for metal matrix composite assemblies and methods for preparing such assemblies. Such assemblies may provide a structure, a subassembly of a structure or another assembly, or be used to support other assemblies, materials, or structures. These metal matrix composite assemblies comprise, at least in part, metal matrix composite bars. The metal matrix composite bars are combined to form the assemblies of the present invention by the use of joining connectors. Joining connectors comprise solid materials fabricated such that they are simultaneously attached to at least one metal matrix composite bar and to at least one other joining connector. Such assemblies may encompass cross-bracing, triangular components, and the like, to advantage. Other materials may be utilized in the assemblies of the present invention to further accentuate the beneficial properties of the metal matrix composites.

### CROSS-REFERENCE TO RELATED APPLICATIONS

The present application claims priority to U.S. Provisional Patent Application No. 60/525,837, filed Dec. 1, 2003, specifically herein incorporated by reference in its entirety.

This invention was made with Government support under contract number DAAD 19-01-2-0006 awarded by the Army Research Laboratory. The Government has certain rights in the invention.

### FIELD OF THE INVENTION

The present invention relates to assemblies comprising metal matrix composites. More particularly, this invention relates to assemblies comprising metal matrix composite bars, where the bars are not directly connected to themselves or to other metal matrix composite bars.

### BACKGROUND OF THE INVENTION

Generally, composite materials are prepared by imbedding a reinforcing material within a matrix material. A common example of a composite material is fiberglass. Fiberglass is glass fibers, which are the reinforcing material, embedded in a cured resin, which constitutes the matrix material.

One class of composites is metallic matrix composites. Metallic matrix composites, also referred to as metal matrix composites, utilize metal as the matrix material. Suitable metals for use as the matrix may be alloys or pure metals. Metallic composites may utilize fibrous or particulate reinforcements. Fibrous reinforcements can be continuous or discontinuous with random or specific orientations. Such fibers may comprise, for example, of aluminum oxide, silicon carbide, or carbon. Particulate reinforcements may comprise, for example, metals, ceramics, carbides, or intermetallic compounds.

The utility of any composite is typically related to its high strength or stiffness to weight, or volume, ratio and, sometimes, to its fatigue resistance. Such beneficial properties of composites are typically a result of load sharing between the matrix materials and reinforcing materials. In many instances, these beneficial properties exceed those of the materials supplanted by the use of the composites.

As a result of their beneficial properties, metallic composites have potential utility in numerous applications. However, the integration of metallic composites into existing or proposed structural designs has typically required the preparation of metallic composites having essentially custom configurations. This requirement for such custom configurations further increases production costs, typically to the point that the use of metallic composites can not be economically justified for most applications.

Metal matrix composites are commercially available as METPREG™ from Touchstone Research Laboratory, Ltd. (R.D. 1, Box 100 B, Triadelphia, W.V. 26059). METPREG™ is a continuous fiber reinforced metal tape. The continuous fibers in this tape are oriented parallel to the length of the tape. The tensile and compressive strengths of this tape are greater than that obtainable with conventional aluminum alloys. Additionally, the modulus of elasticity of this tape is approximately equivalent to that of steel. This tape is available as continuous strips having widths of 0.25 to 1.5 inches and thicknesses of 0.010 to 0.025 inches. Continuous fiber metallic composite bars, particularly tubes and angles, are also available from Touchstone Research Laboratory.

Metal matrix composite bars, specifically tapes, have been previously assembled to produce both flat and cylindrical structures. For example, U.S. Pat. No. 5,968,671 discloses a compound composite assembly comprising aluminum matrix strands reinforced by having tow based aluminum oxide fibers extending the length of the strands. This assembly comprises layers of these strands. In each layer, the strands are mutually parallel to, and essentially touching, each other. The layers are stacked one upon another, with the long axis of the strands in each layer being off-set by some amount to that of neighboring layers by as much as 90 degrees. The individual strands and layers are brazed together to form the compound composite assembly of the invention. In this assembly, aluminum metal matrix strips are in essentially continuous contact with, and bonded to, neighboring strips.

Another example is U.S. Pat. No. 6,455,804 which discloses a method for the fabrication of metal matrix composite assemblies. These assemblies include aluminum matrix braze-clad tape that is applied in layers to a rotating mandrel. As the tape is applied to the mandrel it is brazed to previously applied layers of tape. The result of this application is the formation of an essentially solid wall cylinder from aluminum matrix composite tape. The tape forming the cylinder of this invention is in essentially continuous contact with, and bonded to, previously and subsequently applied layers of the same tape.

These disclosed assemblies potentially have great utility in a variety of applications, but such assemblies are not as readily prepared as would be desired for many other potential metal matrix composite applications. Therefore it would be advantageous to enable ready production of metal matrix composite assemblies that could be readily integrated into existing or proposed structural designs without the preparation of metallic composites having essentially custom configurations.

### SUMMARY OF THE INVENTION

The present invention provides for metal matrix composite assemblies and methods for preparing such assemblies. Such assemblies may provide a structure, a subassembly of a structure or another assembly, or be used to support other assemblies, materials, or structures. These metal matrix composite assemblies comprise, at least in part, metal matrix composite bars. In the present invention, the metal matrix composite bars are not directly connected to themselves or other metal matrix composite bars. The metal matrix composite bars are combined to form the assemblies of the present invention by the use of joining connectors. Joining connectors comprise solid materials fabricated such that they may be simultaneously attached to a metal matrix composite bar and to at least one other joining connector. The assemblies of the present invention are prepared by connecting the joining connectors of at least two metal matrix composite bars. The bars may be bent as required to provide the desired form of an assembly. The design of the assembly should be such that the weight and/or strength advantages provided by the metal matrix composite are utilized. Such assemblies may encompass cross-bracing, triangular components, and the like, to advantage. Other materials may be utilized in the assemblies of the present invention to further accentuate the beneficial properties of the metal matrix composites.

The invention may include an assembly having a first metal matrix composite bar with a first joining connector and a second metal matrix composite bar with a second joining connector. The first joining connector and the second joining connector are in mating relationship to one another.

The metal matrix composites used in the present invention are preferably continuous fiber reinforced metal bars, including tapes, tubes, angles, channels, and the like. The matrix metal used in these composites may be any metal, including pure metals and alloys of metals. Preferably, the matrix metal is a light weight metal and may include, but is not limited to, aluminum, aluminum alloys, magnesium, magnesium alloys, and the like. The continuous fiber reinforcement of such metal matrix composites may include, but is not limited to, aluminum oxide, basalt, glass, quartz, boron, silicon carbide, carbon fibers, and the like. Such continuous fiber reinforcement can be oriented parallel to the length of the metal matrix composite bar.

The use of the continuous fiber reinforced metal bars of the present invention is particularly advantageous as such metal matrix composites can exhibit tensile strengths, compressive strengths, and/or moduli of elasticity typically greater than conventional materials of similar size or weight. Such beneficial mechanical and/or physical properties may impact on the properties of the assemblies of the present invention to provide for structures, sub-assemblies, supports, and the like, having mechanical and/or physical properties which can be superior to those of similar assemblies constructed solely of conventional materials.

The metal matrix composite assemblies of the present invention may be readily assembled and can provide assemblies, structures, supports, or sub-assemblies, and the like, that can exhibit high strength and stiffness coupled with relatively low mass. Additionally, such assemblies may withstand exposure to elevated temperatures higher than can be tolerated by polymeric composites. The assemblies of the present invention may replace or otherwise supplant assemblies, sub-assemblies, structures, and the like that would otherwise be constructed using conventional materials.

Such assemblies are expected to be particularly suitable for lightweight, stiff support structures for space booms, satellite structures, mirror backings, solar panel supports, wall reinforcement, and the like.

### DESCRIPTION OF THE FIGURES

FIGS. 1 (A)-(D) illustrate the attachment of a joining connectors to a metal matrix composite bar in accordance with certain embodiments of the invention.

FIGS. 2(A)-2(D) illustrate the mutual attachment of two, or more, joining connectors in accordance with certain embodiments of the invention.

FIGS. 3(A)-3(C) illustrate joining connectors in accordance with certain embodiments of the invention.

FIG. 4 illustrates (A) a joining connector in accordance with an embodiment of the invention, and (B) an assembly of the present invention in accordance with an embodiment of the invention.

FIGS. 5(A)-(C) illustrates several examples of joining connectors that are designed to be connected to one or more metal matrix composite bars or other joining connectors in accordance with certain embodiments of the invention.

FIG. 6 illustrates another type of joining connector in accordance with another embodiment of the invention.

FIG. 7 illustrates an assembly of the present invention in accordance with an embodiment of the invention.

### DETAILED DESCRIPTION OF THE INVENTION

The present invention provides for assemblies comprising metal matrix composite bars. The assemblies of the present invention may provide a structure, a subassembly of a structure, a part of another assembly, or be used to support other assemblies, materials, or structures. Minimally, the assemblies of the present invention comprise two metal matrix composite bars and two joining connectors. More often, these assemblies comprise more than two metal matrix composite bars more than two joining connectors. The assemblies of the present invention may also comprise materials other than metal matrix composite bars.

The assemblies of the present invention use metal matrix composite bars that are not directly connected to themselves or to other metal matrix composite bars. The metal matrix composite bars are combined to form the assemblies of the present invention by the use of joining connectors. Joining connectors comprise solid materials fabricated such that they may be simultaneously attached to a metal matrix composite bar and to at least one other joining connector. The assemblies of the present invention are prepared by connecting the joining connectors of at least two metal matrix composite bars. The combining of the metal matrix composite bars may result in a linear arrangement of the bars. Alternatively, the combining may result in the bars being at any angle relative to each other.

The metal matrix composite bars may comprise any metal matrix composite that provides for bars having properties compatible with the mechanical and environmental requirements of the application in which the assembly of the present invention will be utilized. Suitable metal matrix composites may utilize continuous fibers, discontinuous fibers, or particulates as the reinforcing material and a metal or metal alloy as the matrix material. Typically, useful reinforcing materials are those that exhibit mechanical properties superior to the matrix metal and are not significantly degraded by any processing conditions required to form the composite or by contact with the matrix metal during of after such processing.

The metal matrix composite bars used in the present invention are preferably continuous fiber reinforced metal matrix composites. The matrix metal of these metal matrix composites is preferably a light weight metal and may comprise, but is not limited to, aluminum, aluminum alloys, magnesium, magnesium alloys, and the like. The continuous fiber reinforcement of such metal matrix composites may comprise, but is not limited to, aluminum oxide fibers, basalt fibers, glass fibers, quartz fibers, boron fibers, silicon carbide fibers, carbon fibers, and the like. Such continuous fiber reinforcement is typically oriented parallel to the length of the metal matrix composite bar. Other continuous fiber orientations can be utilized. For example, the fiber orientation can be transverse, or any orientation between parallel and transverse, to the length of the metal matrix composite bar. For example, the fiber arrangement of a metal matrix composite tube may be hoop or helical.

The use of the continuous fiber reinforced metal matrix composite bars in the present invention is advantageous as such metal matrix composites can exhibit tensile strengths, compressive strengths, and moduli of elasticity typically greater than conventional materials of similar size or weight. Such beneficial mechanical properties may impact on the properties of the assemblies of the present invention to provide for structures, supports, sub-assemblies, and the like having mechanical properties superior to those structures, supports, or other assemblies prepared from conventional, typically monolithic, materials. Additionally, metal matrix composites can tolerate higher temperatures than polymers and polymeric composite materials. As such, the use of metal matrix composites can provide for strong light weight assemblies compatible with higher temperature environments.

The metal matrix composite bars utilized in the present invention may have circular, square, rectangular, triangular, polygonal, ellipsoid, “I”, “L”, “U”, or other, cross sectional shapes. The lengths and cross-sectional dimensions of these bars are selected based on the design requirements and characteristics of the desired assembly. Some of these metal matrix composite bars may be commonly referred to as tapes, square tubes, round tubes, rods (including wires), round bars, channels, angles, or the like. Metal matrix composite tape may be produced in a number of sizes and is available commercially in widths of 0.25 to 1.25 inches and thicknesses of about 0.008 inches to about 0.030 inches (METPREG™, Touchstone Research Laboratory, Ltd.). Metal matrix composite tubes, angles, channels, and the like may have wall thicknesses in a range similar to that of metal matrix composite tape. Typically, the outer diameters, leg lengths, and the like of metal matrix composite tubes, angles, channels, and the like, reflect those of similar conventional metal bars having comparable wall thicknesses.

More than one type of metal matrix composite bar may be used in a given assembly. That is, a given assembly may comprise metal matrix composite bars having different cross-sectional shapes and/or dimensions. For example, a three dimensional rectangular assembly having edges comprising metal matrix composite tubes may utilize metal matrix composite tape as angular bracing between opposite intersections of such tubes. Additionally, metal matrix composite bars having different compositions may be used in a given assembly. For example, a metal matrix composite bar comprising an aluminum matrix and an aluminum oxide fiber reinforcement, a metal matrix composite bar comprising a magnesium matrix with a carbon fiber reinforcement, and a composite bar comprising a zinc matrix with a silicon carbide particulate reinforcement may all be utilized in the same assembly. The ability to combine different types of metal matrix composite bars in a single assembly is advantageous as assembly designs can be optimized for the intended application with respect to strength, mass, stiffness, and/or cost.

Also, other materials may be utilized in the present invention to reduce the metallic matrix composite bar content of an assembly for economic or other reasons. Such other materials can provide for support of the assembly or component parts of the assembly. These other materials may be of any geometric configuration. Typically, such materials are utilized in less demanding load bearing support functions. Such other materials may be, but are not limited to, metals, ceramics, plastics, polymeric composites, wood, and the like. Additionally, the assemblies of the present invention may also incorporate other types of metal matrix composites, including those comprising metal matrix composite bars in continuous contact with each other. It is generally desirous that any assembly utilizing other materials be so designed that the resistance to any significant applied force is provided by the metal matrix composite portion of that assembly.

The assemblies of the present invention are prepared by connecting the joining connectors of a least two metal matrix composite bars. Typically, the length of a metal matrix composite bar is greater than the maximum cross-sectional dimension of that bar. The design of the assembly preferably should be such that the weight and/or strength advantages provided by use of metal matrix composites are utilized.

For example, continuous fiber reinforced metal matrix composites are typically anisotropic materials with respect to strength and/or stiffness. Those continuous fiber reinforced bars having such fibers oriented along the length of the bar typically exhibit significant strength in tension or compression (along the length of the bar). Therefore, assemblies are preferably designed such that the metal matrix composite bars comprising the assembly are put into tension or compression by any significant applied force. Such assemblies may encompass cross-bracing, triangular component arrangement, and the like, to provide for the desired resistance to forces applied to the assembly. Examples of such assemblies may include, but are not limited to, isogrids, I-beams, trusses, or other types of structural elements. Other assemblies can include those structures that are combinations of these structural elements. Still other assemblies can incorporate novel designs to provide the structures, structure subassemblies, supports, or the like, based on the teachings of the present invention.

Some assembly designs require the use of bent metal matrix composite bars. Depending on the type and shape of the metal matrix composite, the metal matrix composite bar utilized to form the desired assembly may be bent to provide a desired configuration. Heating of the metal matrix composite, even to temperatures above which the matrix metal is initially softened, may be used to facilitate bending. Bending of bars can provide for more than one connection between two individual bars.

Joining connectors have provision for the attachment of minimally one metal matrix composite bar to at least one other joining connector. Joining connectors may also have provision for the attachment of multiple metal matrix composite bars to one or more other joining connectors. Furthermore, joining connectors may also have provision for the attachment of the joining connector, and resulting assembly of the present invention, to other assemblies, materials, or structures. Joining connectors may be constructed from essentially any solid material. Preferably, joining connectors are prepared from mechanically robust, strong, materials such as, for example, metals, metal matrix composites, engineering plastics, polymeric composites, ceramics, and the like. Additionally, joining connectors are preferably designed, with respect to both form and materials of construction, to withstand, without any significant loss of performance, the forces and environments to which the attached metal matrix composite bars may be exposed while still not contributing any unnecessary mass or volume to the resultant assembly.

A single joining connector may have provision for the attachment of more than one metal matrix composite bar. For such a joining connector, common or different methods may be used to attach each bar. Also, such a joining connector may be designed such that the attached metal matrix composite bars have certain desired spatial orientations. Similarly, a joining connector may have provision for the attachment to more than one other joining connector. Common or different methods may be used for attachment to each other joining connector. Additionally, joining connector-joining connector attachments and joining connector-metal matrix composite bar attachments may be further strengthened or supported by the use of various types of mechanical restraints and bracing components.

A joining connector may be attached to any location on a metal matrix composite bar. Most commonly, however, joining connectors are attached to bar ends. Attachment of a metal matrix composite bar to a joining connector may be accomplished by any of a number of means. For example, the joining connector may have a cavity into which a metal matrix composite bar may be inserted to provide for attachment. The cavity may have a bottom which limits the depth to which the bar may be inserted. Alternatively, the cavity may extend completely through the joining connector such that the joining connector may be positioned at any position along the bars length. As another example, the joining connector may have a protuberance or unthreaded stud, the size of which corresponds to the inside dimensions of a hollow metal matrix composite bar such as a round tube, square tube, or channel. Insertion of the unthreaded stud into the hollow of the bar will then provide for attachment of the joining connector to the metal matrix composite bar. As still another example, a surface of the joining connector may be configured such that it matches a surface of the metal matrix composite bar. Overlaying of the matching surfaces of the joining connector and the metal matrix composite bar can provide for attachment.

Essentially any type of attachment between a joining connector and a metal matrix composite bar, including those exemplified above, may be established or further secured by the use of, for example, adhesive bonding, welding, brazing, soldering, or the like. Also, such attachments may be established or further secured by the use of any of a number of mechanical methods, including, but not limited to, friction fits, interference fits, swaging, clamping, screws, pins, clips, springs, bolting (i.e. bolt and nut), and the like. Additionally, a metal matrix composite bar may be modified to further strengthen its attachment to a joining connector. Such modifications can involve the removal of limited portions of the bar, especially portions at or near the joining connector, to facilitate the use of screws, pins, bolts and nuts, and the like, to established or further secure the attachment of the bar to the joining connector.

Removal of limited portions of the metal matrix composite bar may be accomplished using conventional machining methods. Alternatively, such removal may be accomplished by heating the metal matrix composite such that the matrix metal is softened and then while still softened, forming the desired configuration in the metal matrix composite. This method can be advantageous as fiber reinforcements, if present, may be pushed aside, rather than cut, during hole formation. As a result, this method may result in less composite strength loss due to material removal as compared to conventional methods of material removal.

The attachment of a joining connector to another joining connector may be by any method that provides for a secure attachment. For example, a portion of a joining connector, or portions of matching joining connectors, may be configured so as to provide for such a secure attachment. Secure attachments may be made through connectors having mating relationships to each another such as connector that provide attachment through male and female engagement. Such configurations can include, but are not limited to, those provided by cams (including interlocking cams), dovetails, doll-heads, t-slots, threaded fittings, and the like. Essentially any type of attachment between joining connectors may be further secured or established by the use of, for example, adhesive bonding, welding, brazing, soldering, or the like. Additionally, such attachments may be secured or established by the use of any of a number of mechanical methods, including, but not limited to, friction fits, interference fits, swaging, clamps, screws, pins, clips, springs, bolting (i.e. bolt and nut), and the like.

It is not necessary that all joining connectors used in a given assembly attach to each other using the same attachment design. Different connectors, even when used in the same assembly, could have different attachment designs. Such different configurations could be complimentary, such as the male and female portions of a dovetail joint. Such configurations could also be completely different, as an assembly having male and female dovetail joining connectors, and male and female threaded joining connectors. The only requirement is that the number and type of different joining connector attachment designs utilized in a given assembly provide the desired assembly. In addition to attachment design, the angle such attachment makes to one or more other joining connectors may be different.

Preferably, joining connector attachment methods are readily implemented so that the assemblies of the present invention can be rapidly fabricated. The attachment design of joining components may be such that secure joining of lengths of metal matrix composites by the application of a minimal force upon the component in provided. That is, such joining components may be designed to provide for an essentially “snap together” means of connecting metal matrix composite lengths. The ability to “snap together” lengths of metal matrix composites is expected to be especially useful in the assembling of structures in the essentially weightless conditions of outer space.

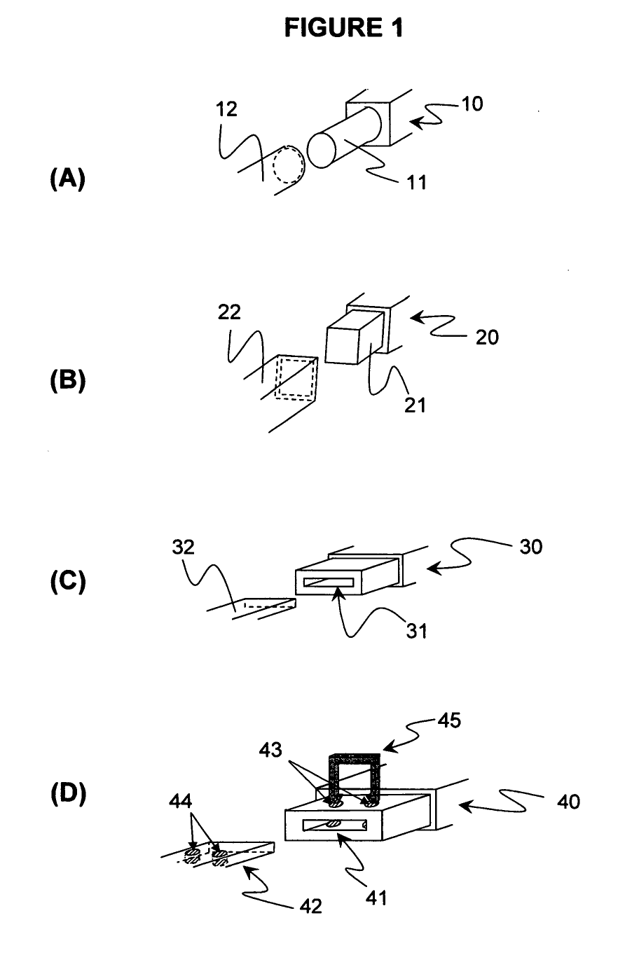

FIG. 1 illustrates the attachment of a joining connector to a metal matrix composite bar. The methods shown in this FIG. 1 are for illustrative purposes only and should not be considered limiting as a great number of potentially suitable connector designs are possible. For the purposes of clarity, only the portion of the joining connector used to secure the metal matrix composite bar to the connector is illustrated in this Figure.

FIG. 1 (A) illustrates a portion of a joining connector (10) having a cylindrical unthreaded stud (11) sized such that it may be inserted into a metal matrix composite round tube (12). Preferably, the stud (11) is sized to provide a tight fit within the tube (12). The stud may be fixed within the tube by use of any of the previously mentioned methods. FIG. 1 (B) illustrates a portion of a joining connector (20) having a rectangular stud (21) sized such that it may be inserted into a metal matrix composite square tube (22). Preferably, the stud (21) is sized to provide a tight fit within the tube (22). The stud may be fixed within the tube by use of any of the previously mentioned methods. FIG. 1 (C) illustrates a portion of a joining connector (30) having a rectangular cavity (31) sized such that insertion of a metal matrix composite bar having a rectangular cross-section (32), such as a tape, is possible. The cavity (31) may extend completely through the joining connector (30) such that the connector may be positioned at some mid-point along the length of the composite bar (32). Preferably, the cavity (31) is sized to provide a tight fit to the bar section (32). The bar section may be fixed within the cavity by use of any of the previously mentioned methods. FIG. 1 (D) illustrates a portion of a joining connector (40) having a rectangular cavity (41) sized such that insertion of a metal matrix composite bar having a rectangular cross-section (42), such as a tape, is possible. Preferably, the cavity (41) is sized to provide a tight fit to the bar section (42). Holes are provided in both the joining connector (43) and in the metal matrix composite bar (44). The holes are located and sized such that, after insertion of the bar (42) into the joining connector cavity (41), the holes are co-linear. After insertion, a spring clip (45) may be placed into and through the co-linear holes to fix the bar (42) within the connector (40). Alternatively or additionally, the bar may be fixed within the cavity by use of any of the previously mentioned methods.

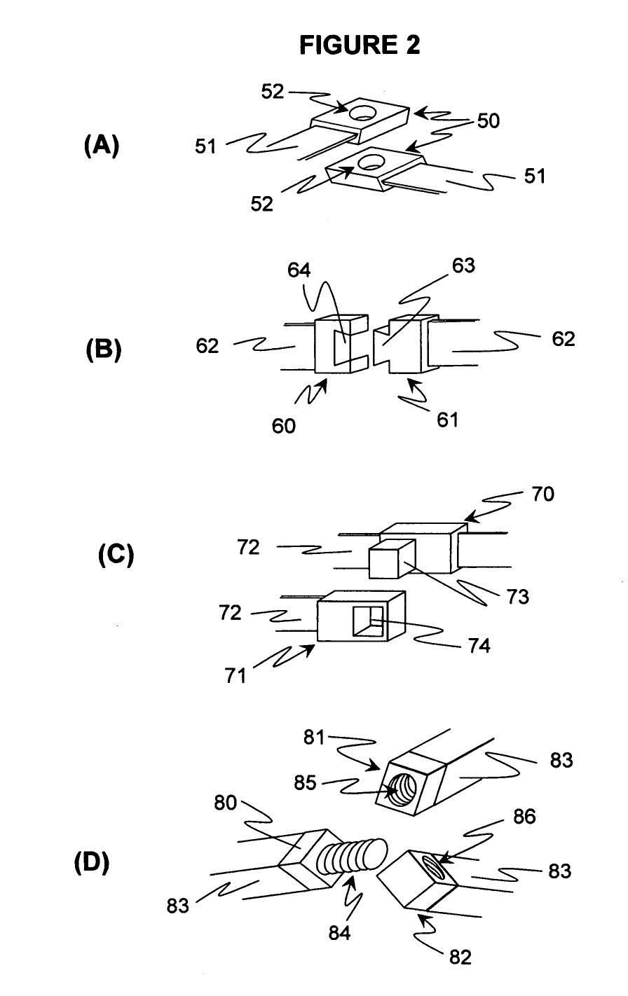

FIG. 2 illustrates the mutual attachment of two, or more, joining connectors in accordance with certain embodiments of the invention. The embodiments shown in FIG. 2 are for illustrative purposes only and should not be considered limiting as a great number of potentially suitable connector designs are possible. For the purposes of clarity, only the portion of the joining connector used to secure one joining connector to another is illustrated in this Figure.

FIG. 2 (A) illustrates two joining connectors (50), each having an attached metal matrix composite tape (51). Each joining connector has a hole (52) extending through its body. Although other joining methods may be used, such joining connectors may be most readily joined by bolting through the aligned holes. As illustrated, the use of such joining connectors provides for the joining of the bars at any simple angle between 0 and 180 degrees. Although not illustrated, it may also be readily envisioned that such types of joining connectors may be bent or have holes placed at various angles to provide for the joining of the bars at compound angles.

FIG. 2 (B) illustrates two joining connectors (60, 61), each having an attached bar of metal matrix composite tape (62). One joining connector (61) has a dovetail shaped protuberance (63) while the other connector (60) has an open dovetail shaped cavity (64). Fitting together of the two connectors provides for a dovetail joint which secures the bars of metal matrix composite tape (62) in a co-linear arrangement. Although not illustrated, it may also be readily envisioned that the dovetail portions of the joining connectors may be located at essentially any angle relative to the length or width of the composite tape. By selection of such angles, the attached sections of metal matrix composite bar may be positioned at different relative angles. The dovetail joint may be secured by use of any of the previously mentioned methods.

FIG. 2 (C) illustrates two joining connectors (70, 71), each having an attached metal matrix composite tape (72). The metal matrix composite tape (72) passes through one of the connectors (70) such that the connector is located at some mid point along the length of the tape. This joining connector (70) has a cube shaped protuberance (73). The other connector (71) has an open cube shaped cavity (74). The two connectors may be fitted together by inserting the protuberance (73) into the cavity (74). By use of a cubic protuberance and cavity, the connectors may be fitted together such that the attached sections of metal matrix composite tape (72) may be positioned at relative angles of 0, 90, 180, and 270 degrees. The connectors may be secured to each other by use of any of the previously mentioned methods. A particularly convenient method to secure the connectors after fitting together is by driving a screw, having a head diameter greater than the cube width, into a threaded hole which had been previously produced in the resulting exposed face of the cube.

FIG. 2 (D) illustrates three joining connectors (80, 81, 82), each having an attached metal matrix composite square tube (83). One connector has a threaded stud (84) co-linear with the major axis of the attached metal matrix composite tube. The other joining connectors (81, 82) have holes (85, 86) threaded to match the threads of the stud (84). The joining connectors having holes differ in that one connector (81) has a hole (85) co-linear with the major axis of the attached tube. The other connector (82) has a hole (86) situated at a right angle to the major axis of the attached tube. Such connectors are joined by screwing the threaded stud (84) into one of the threaded holes (85 or 86). In this manner, the joining connectors may be combined to provide a linear or right angle orientation of the metal matrix composite tube sections. As desired, the connectors may be secured to each other by use of any of the previously mentioned methods.

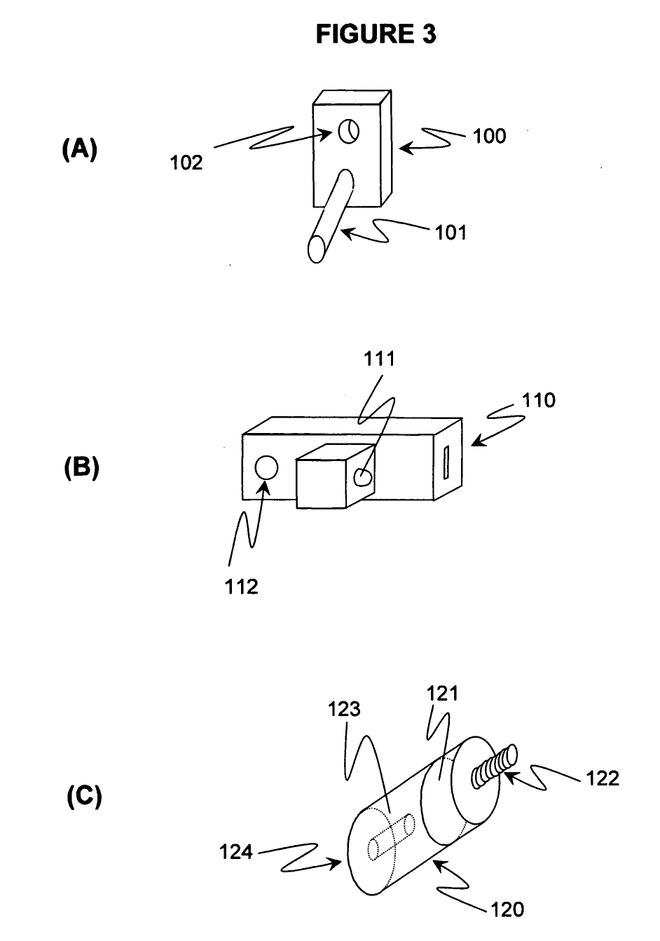

FIG. 3 illustrates some joining connectors in accordance with certain embodiments of the invention. The joining connectors shown in FIG. 3 are for illustrative purposes only and should not be considered limiting as a great number of potentially suitable connector designs are possible. FIG. 3 (A) illustrates a joining connector (100) having a unthreaded stud (101) sized to slightly less than the interior diameter of a given metal matrix composite tube. This stud provides a means for the attachment of a metal matrix composite tube to the joining connector. Such an attachment may be secured by any of the previously discussed methods. The joining connector also has a hole (102) extending through the connector. A bolt or screw may be inserted through this hole to secure the attachment of this connector to another connector. Also, the illustrated connector is bent such that the long axis of the bolt or screw is at 30 degrees to that of an attached metal matrix composite tube.

FIG. 3 (B) illustrates a joining connector (110) very similar to that joining connector shown in FIG. 2 (C) as (70) with two exceptions. The first exception is that this joining connector has a spring loaded ball (111) secured in the cube shaped protuberance such that this spring loaded ball slightly extends outside the surface of the cube shaped protuberance. This protuberance is designed to be connected to a second joining connector. This second joining connector has a cube shaped cavity, similar to that shown in FIG. 2 (C) as (74), having indents in the cavity walls. These indents are so sized and positioned as to provide a location for the spring loaded ball (111), of the illustrated joining connector (110), to come to essentially full extension out of the cube shaped protuberance surface after insertion of the protuberance into the cube shaped cavity of the second connector. In this manner, the illustrated joining connector may be attached to a second joining connector. This method of attachment is similar to that traditionally used to attach a socket wrench to a socket. The second exception is that the illustrated joining connector has a hole (112) extending through the body of the joining connector. This hole is intended to be used for the attachment of the joining connector, and the assembly of which that joining connector is a part of, to another material or other assemblies, materials, or structures by the use of screws, bolts, nails, and the like.

FIG. 3 (C) illustrates still another type of joining connector. The illustrated connector (120) comprises two sections. One section (121) has an attached threaded stud (122). The other section (123) has a hole (124) into which a metal matrix composite bar may be inserted and secured. This joining connector is constructed such that the major axes of the stud and the hole are co-linear. This joining connector is also constructed such that the section of the connector having the stud may be rotated around the axis of the stud independent of any rotation of the section having the hole. That is, a swivel action between any connected metal matrix composite bar and any joining connector attached to the stud is provided.

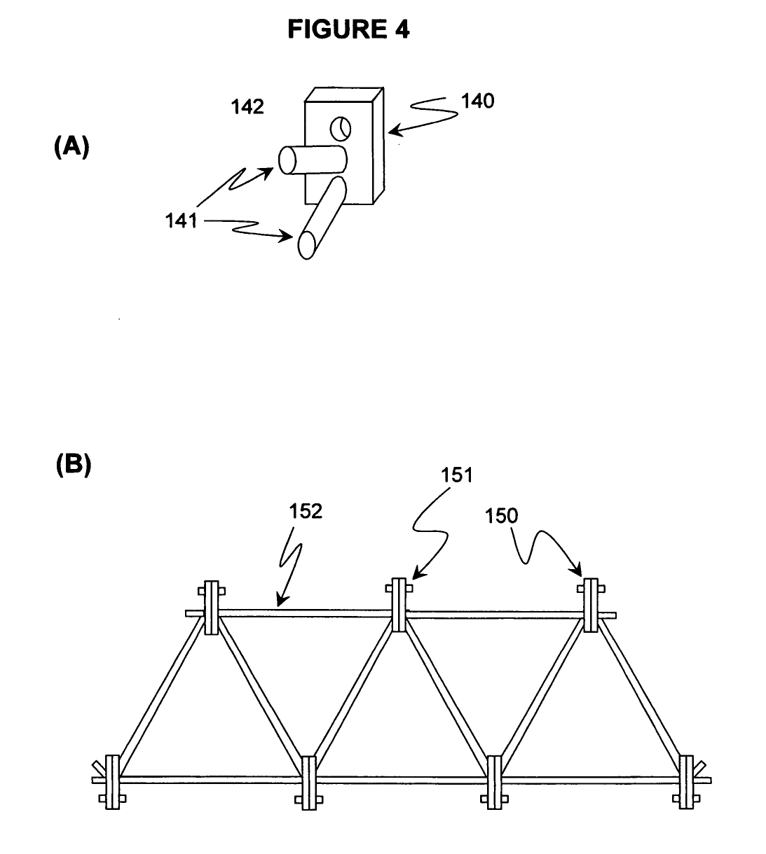

FIG. 4 (A) illustrates another joining connector (140), this connector has two attached unthreaded studs (141) angled at about 30 degrees to each other. The studs are sized such that a tubular bar of a metal matrix composite may be positioned over and secured to each stud. The joining connector also has a hole (142) through it body. This hole provides a means for attaching other joining connectors to this connector by use of, for example, a bolt and nut.

FIG. 4 (B) illustrates an assembly of the present invention prepared using a number of joining connectors (150) of the design shown in FIG. 4 (A), connected with bolts (151), and a number of metal matrix composite bars (152). This assembly may provide a structure, a subassembly of a structure, a part of another assembly, or be used to support other assemblies, materials, or structures.

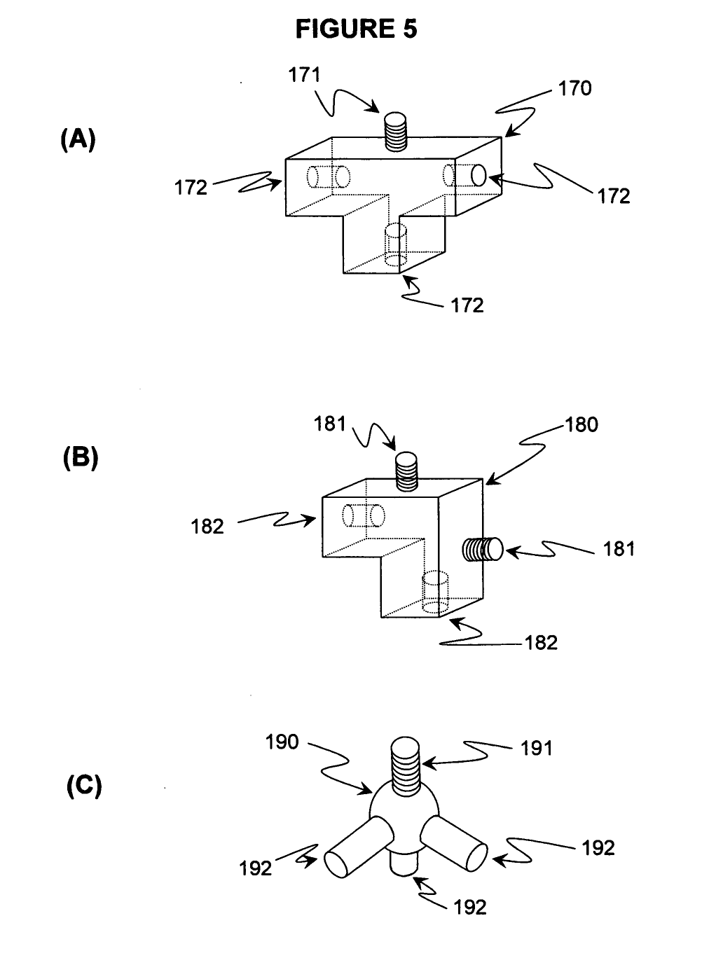

FIG. 5 illustrates several examples of joining connectors that are designed to be connected to one or more metal matrix composite bars or other joining connectors. FIG. 5 (A) illustrates a joining connector (170) having a threaded stud (171) for attachment to another joining connector and three cavities (172). The cavities are sized such that metal matrix composite bars having cross sectional sizes slightly less than those of the cavities may be secured within those cavities. FIG. 5 (B) illustrates a joining connector (180) having two threaded studs (181) for attachment to other joining connectors and two cavities (182) for attachment of metal matrix composite bars having cross sectional sizes slightly less than those of the cavities. Such bars may be secured within those cavities. FIG. 5 (C) illustrates a joining connector (190) having one threaded stud (191) and three unthreaded studs (192). The arrangement of the studs is similar to that of a tetrahedral in that the angle between each pair of studs is approximately 109.5 degrees. The unthreaded studs have cavities extending along their lengths. These cavities are for attachment of metal matrix composite bars having cross sectional sizes slightly less than those of the cavities. Such bars may be secured within those cavities.

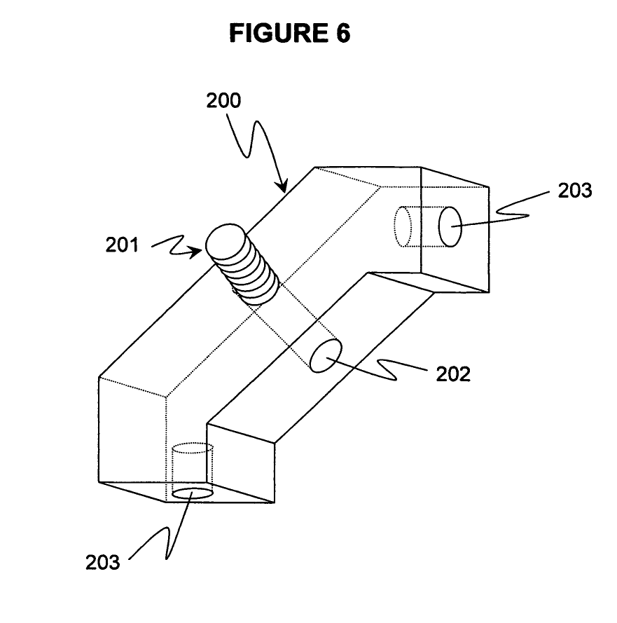

FIG. 6 illustrates another type of joining connector. This joining connector (200) has one threaded stud (201), one hole (202) extending through the body of the connector as shown, and two cavities (203). The threaded stud is for attachment of other joining connectors. The hole is used to attached this joining connector to other joining connectors. The cavities are for attachment of metal matrix composite bars having cross sectional sizes slightly less than those of the cavities. Such bars may be secured within those cavities.

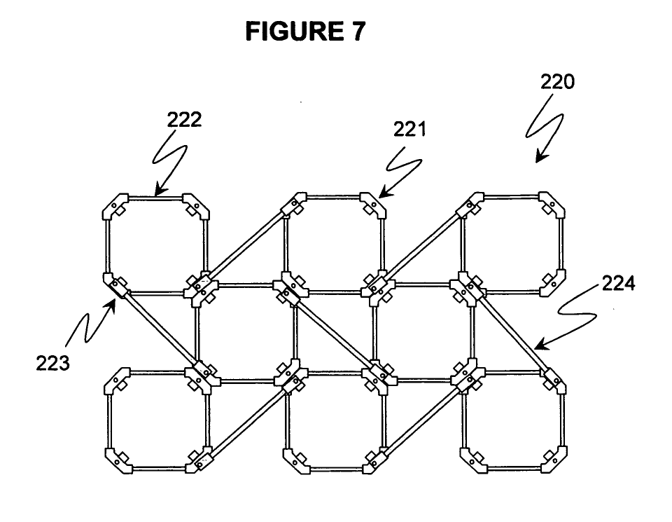

FIG. 7 illustrates an assembly (220) of the present invention prepared using a number of joining connectors (221) of the design shown in FIG. 6 and a number of metal matrix composite tubular bars (222). This assembly also utilizes a number of joining connectors (223) of the design shown in FIG. 2 (A) connected to metal matrix composite tape (224). For this assembly, the metal matrix composite tape, and associated joining connectors serve as braces to the tubular bar assembly. The resultant assembly may provide a structure, a subassembly of a structure, a part of another assembly, or be used to support other assemblies, materials, or structures.

As exemplified by the previously discussed illustrations, the assemblies of the present invention may be of any size. By such means, larger, more complex, or geometrically different assemblies may be prepared. Such different assemblies may encompass, but are not limited to, repeating structural units, curved geometries, and other known geometric shapes. Additionally, the methods exemplified by these representations may be used to prepare assemblies of various designs for use as structures, supports, and the like. Additionally, as has been previously mentioned, clamps, mechanical restraints, and bracing components of various designs may be utilized to strengthen or otherwise reinforce the joining methods of the present invention. These clamps, mechanical restraints, and bracing components may comprise any solid material having mechanical properties suitable for the application.

Additionally, a kit may be provided to enable relatively rapid production of custom assemblies according to embodiments of the invention. Such a kit may include an assortment of metal matrix composite bars, including, but not limited to, tapes, tubes, or angles, may be provided, from which the assemblies of the present invention may be readily prepared. Additionally, the bars may be of various defined lengths so as to provide for the rapid production of certain assembly designs. The kit may include a plurality of joining connectors such as those previously described. Such joining connectors may be joined to individual bars in the kit. Alternatively, the joining connectors may be provided individually for attachment to the individual bars at a later time. Further, the kit may include joining agents or tools for connecting the joining connector to the metal matrix composite bars and/or the mating of the joining connectors during construction of an assembly. The joining agents may include, adhesives, solder, adhesive tape, clamps, bracing components and/or other similar agents. The tools may include devices for welding, soldering, brazing, or the like. Further, tools may be provided to enable cutting bars to desired lengths or rapid attachment of joining connectors to the bars and joining connectors to each other.

The metal matrix composite assemblies of the present invention may be readily assembled to provide structures, supports, or sub-assemblies that may exhibit high strength and stiffness coupled with relatively low mass. Such assemblies are therefore expected to be useful for the support, strengthening, and/or stiffening of other structures or materials. Additionally, such assemblies may withstand exposure to elevated temperatures higher than can be tolerated by polymeric composites. Therefore structures comprising assemblies of the present invention may replace or otherwise supplant structures that would otherwise comprise alternative materials. As the assemblies of the present invention comprise metal matrix composites, such that the afore mentioned beneficial properties are present, they are particularly suitable for lightweight, stiff support structures for space booms, satellite structures, mirror backings, solar panel supports, wall reinforcement, and the like.

The above examples are not to be considered limiting and are only illustrative of a few of the many types of metallic-polymeric composites that may be prepared. The present invention may be varied in many ways without departing form the scope of the invention and is only limited by the following claims.

1. An assembly comprising a first metal matrix composite bar having a first joining connector and a second metal matrix composite bar having a second joining connector, wherein said first joining connector and said second joining connector are in mating relationship to one another.

2. The assembly of claim 1, wherein said first metal matrix composite bar is a continuous fiber reinforced metal matrix composite bar.

3. The assembly of claim 2, wherein the first metal matrix composite bar comprises a matrix metal selected from the group consisting of aluminum, an aluminum alloy, magnesium, and a magnesium alloy.

4. The assembly of claim 2, wherein the first metal matrix composite bar comprises an aluminum oxide continuous fiber reinforcement.

5. The assembly of claim 2, wherein the first metal matrix composite bar comprises a continuous fiber reinforcement selected from the group consisting of basalt fibers, glass fibers, quartz fibers, boron fibers, silicon carbide fibers, and carbon fibers.

6. The assembly of claim 1, wherein said first and second joining connectors are joined by a threaded connection.

7. The assembly of claim 1, wherein said first and second joining connectors are joined by a dovetail connection.

8. The assembly of claim 1, wherein said first and second joining connectors are connected through male and female engagement.

9. The assembly of claim 1, wherein said first joining connector is adapted to connect to more than one joining connector.

10. The assembly of claim 1, wherein said first and second joining connectors are joined by mechanical methods.

11. The assembly of claim 1, wherein the first and second joining connectors are joined by the use of at least one of adhesive bonding, welding, brazing, or soldering.

12. A kit for the rapid preparation of assemblies, the kit comprising a plurality of metal matrix composite bars of various sizes and a plurality of joining connectors.

13. The kit of claim 12 wherein at least a portion of the joining connectors are attached to at least a portion of the plurality of metal matrix composite bars.

14. The kit of claim 12 further comprising a joining agent selected from the group consisting of adhesives, solder, adhesive tape, clamps, and bracing components.

15. The kit of claim 12, further comprising tools.
